(19) United States
(12) Patent Application Publication
(10) Pub. No.: US 2025/0245689 A1
(43) Pub. Date: Jul. 31, 2025

(54) E-COMMERCE INCENTIVE TASK SCREENING METHOD AND APPARATUS, ELECTRONIC DEVICE, AND STORAGE MEDIUM

(71) Applicant: Beijing Volcano Engine Technology Co., Ltd., Beijing (CN)

(72) Inventors: Yang SUN, Beijing (CN); Yuqi ZHANG, Beijing (CN); Xiaoming YIN, Beijing (CN)

(21) Appl. No.: 19/013,184

(22) Filed: Jan. 8, 2025

(30) Foreign Application Priority Data
Jan. 31, 2024 (CN) 202410139578.9

(51) Int. Cl. G06Q 30/0207

(52) U.S. Cl. CPC G06Q 30/0222

(57) ABSTRACT

The present disclosure relates to the field of data processing technologies, and discloses a method, an apparatus, an electronic device, and a storage medium for e-commerce incentive task selection. The present disclosure provides a method for e-commerce incentive task selection, including: obtaining an e-commerce incentive task to be selected and a target to be incentivized; determining a causal relationship between the e-commerce incentive task and the target to be incentivized based on expert knowledge of an e-commerce scenario; and predicting an impact of the e-commerce incentive task on the target to be incentivized based on the causal relationship, to obtain a selection result of the e-commerce incentive task.

### CROSS-REFERENCE TO RELATED APPLICATION(S)

This application claims priority to Chinese Application No. 202410139578.9 filed in Jan. 31, 2024, the disclosure of which is incorporated herein by reference in its entirety.

### FIELD

The present disclosure relates to the field of data processing technologies, and in particular, to a method, an apparatus, an electronic device, and a storage medium for e-commerce incentive task selection.

### BACKGROUND

In the related art, in an e-commerce scenario, to detect whether an e-commerce incentive task can effectively incentivize a target to be incentivized, a to-be-tested state in which the target to be incentivized does not use an e-commerce incentive task to be selected is compared with a target state after the e-commerce incentive task is used, and then whether the e-commerce incentive task is effective is predicted based on the comparison result.

### SUMMARY

In view of the above, the present disclosure provides a method, an apparatus, an electronic device, and a storage medium for e-commerce incentive task selection, to solve the problem of inaccurate prediction results of the effectiveness of a strategy.

According to a first aspect, the present disclosure provides a method for e-commerce incentive task selection, the method comprises:
obtaining an e-commerce incentive task to be selected and a target to be incentivized;
determining a causal relationship between the e-commerce incentive task and the target to be incentivized based on expert knowledge of an e-commerce scenario, wherein the causal relationship is obtained through a pre-constructed indicator causal graph, the indicator causal graph is configured to represent a causal relationship between a plurality of candidate incentive indicators and a target indicator corresponding to the target to be incentivized in the e-commerce scenario, and the plurality of candidate incentive indicators comprise a target incentive indicator corresponding to the e-commerce incentive task; and
predicting an impact of the e-commerce incentive task on the target to be incentivized based on the causal relationship to obtain a selection result of the e-commerce incentive task.

According to a second aspect, the present disclosure provides an apparatus for e-commerce incentive task selection, the apparatus comprises:
an obtaining module, configured to obtain an e-commerce incentive task to be selected and a target to be incentivized;
a first processing module, configured to determine a causal relationship between the e-commerce incentive task and the target to be incentivized based on expert knowledge of an e-commerce scenario, wherein the causal relationship is obtained through a pre-constructed indicator causal graph, the indicator causal graph is configured to represent causal a relationship between a plurality of candidate incentive indicators and a target indicator corresponding to the target to be incentivized in the e-commerce scenario, and the plurality of candidate incentive indicators comprise a target incentive indicator corresponding to the e-commerce incentive task; and
a prediction module, configured to predict an impact of the e-commerce incentive task on the target to be incentivized based on the causal relationship to obtain a selection result of the e-commerce incentive task.

According to a third aspect, the present disclosure provides an electronic device, comprising: a memory and a processor, the memory and the processor are communicatively connected with each other, the memory storing computer instructions, and the processor executing the computer instructions to perform the method for e-commerce incentive task selection according to the first aspect or any one of its corresponding implementations.

According to a fourth aspect, the present disclosure provides a computer-readable storage medium, the computer-readable storage medium storing computer instructions, and the computer instructions are configured to enable a computer to perform the method for e-commerce incentive task selection according to the first aspect or any one of its corresponding implementations.

### BRIEF DESCRIPTION OF THE DRAWINGS

In order to more clearly describe the specific embodiments of the present disclosure or the technical solutions in the prior art, the accompanying drawings to be used in the description of the specific embodiments or the prior art will be briefly described below. It is obvious that the accompanying drawings in the following description show some embodiments of the present disclosure. For those of ordinary skill in the art, other accompanying drawings may be derived from these accompanying drawings without creative efforts.

FIG. 1 is a schematic flowchart of a method for e-commerce incentive task selection according to an embodiment of the present disclosure;

FIG. 2 is a schematic flowchart of a method for constructing an indicator causal graph according to an embodiment of the present disclosure;

FIG. 3 is a schematic topological diagram of a global pointing rule according to an embodiment of the present disclosure;

FIG. 4 is a schematic diagram of a rule adjustment control according to an embodiment of the present disclosure;

FIG. 5 is a schematic diagram of an indicator causal graph according to an embodiment of the present disclosure;

FIG. 6 is a schematic diagram of an arrangement adjustment control according to an embodiment of the present disclosure;

FIG. 7 is a partial schematic diagram of an initial indicator causal graph according to an embodiment of the present disclosure;

FIG. 8 is a partial schematic diagram of an indicator causal graph according to an embodiment of the present disclosure;

FIG. 9 is a schematic flowchart of another method for e-commerce incentive task selection according to an embodiment of the present disclosure;

FIG. 10 is a schematic flowchart of a further method for e-commerce incentive task selection according to an embodiment of the present disclosure;

FIG. 11 is a block diagram of a structure of an apparatus for e-commerce incentive task selection according to an embodiment of the present disclosure; and

FIG. 12 is a schematic diagram of a hardware structure of an electronic device according to an embodiment of the present disclosure.

### DETAILED DESCRIPTION OF EMBODIMENTS

In order to make the objectives, technical solutions, and advantages of the embodiments of the present disclosure clearer, the technical solutions in the embodiments of the present disclosure will be described clearly and completely below with reference to the accompanying drawings in the embodiments of the present disclosure. It is obvious that the described embodiments are a part of but not all of the embodiments of the present disclosure. All other embodiments obtained by those of ordinary skill in the art based on the embodiments of the present disclosure without creative efforts shall fall within the protection scope of the present disclosure.

In the related art, to detect whether an e-commerce incentive task can effectively incentivize a target to be incentivized, a to-be-tested state of the target to be incentivized is first determined, and then a target state of the target to be incentivized after executing the e-commerce incentive task in an e-commerce scenario is determined, so that whether the e-commerce incentive task can effectively incentivize the target to be incentivized is predicted based on a comparison result between the target state and the to-be-tested state. However, in an actual prediction process, before executing the e-commerce incentive task, the to-be-tested state of the target to be incentivized may be a result of interference from other incentive tasks, which in turn causes a deviation between the obtained test result and the actual situation.

An embodiment of the present disclosure provides a method for e-commerce incentive task selection, which obtains an e-commerce incentive task to be selected and a target to be incentivized. To determine an impact of the e-commerce incentive task on the target to be incentivized in the e-commerce scenario, a causal relationship between the e-commerce incentive task and the target to be incentivized is determined based on expert knowledge of the e-commerce scenario. The causal relationship is obtained through a pre-constructed indicator causal graph, the indicator causal graph is configured to represent a causal relationship between a plurality of candidate incentive indicators and a target indicator corresponding to the target to be incentivized in the e-commerce scenario, and the plurality of candidate incentive indicators comprise a target incentive indicator corresponding to the e-commerce incentive task. The impact of the e-commerce incentive task on the target to be incentivized is predicted based on the causal relationship, so that an interaction between the e-commerce incentive task and the target to be incentivized can be better understood, thereby making the obtained selection result of the e-commerce incentive task more accurate and effective.

According to an embodiment of the present disclosure, an embodiment of a method for e-commerce incentive task selection is provided. It should be noted that the steps shown in the flowcharts of the accompanying drawings may be performed in a computer system, such as a group of computer-executable instructions. Also, although a logical order is shown in the flowcharts, the steps shown or described may be performed in an order different from that herein in some cases.

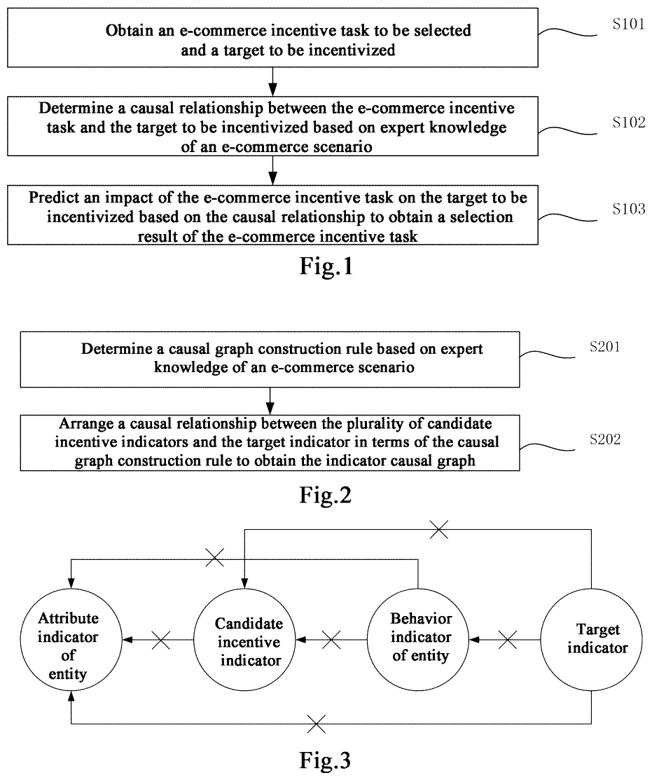

A method for e-commerce incentive task selection is provided in this embodiment, which may be applied to the above computer device, such as a computer, a mobile phone, a tablet computer, and the like. FIG. 1 is a flowchart of a method for e-commerce incentive task selection according to an embodiment of the present disclosure. As shown in FIG. 1, the process includes the following steps.

Step S101: Obtain an e-commerce incentive task to be selected and a target to be incentivized.

The target to be incentivized refers to an object that needs to be followed up and evaluated in an e-commerce scenario, which is closely related to performance and achievements of an organization or an individual. For example, the target to be incentivized may include sales, total income, market share, and the like.

To detect whether the e-commerce incentive task to be selected can promote the target to be incentivized to be in an improved state in the e-commerce scenario, monitoring and evaluation are performed through the target to be incentivized so that the e-commerce incentive task can be targeted and selected, thereby achieving the objectives of effectively managing performance and formulating effective incentive measures.

Step S102: Determine a causal relationship between the e-commerce incentive task and the target to be incentivized based on expert knowledge of an e-commerce scenario.

The causal relationship is obtained through a pre-constructed indicator causal graph. The indicator causal graph is configured to represent a causal relationship between a plurality of candidate incentive indicators and a target indicator corresponding to the target to be incentivized in the e-commerce scenario. The plurality of candidate incentive indicators comprise a target incentive indicator corresponding to the e-commerce incentive task.

To determine an impact that may be generated on the incentive task to be incentivized by the e-commerce incentive task, the interaction between the target indicator and the plurality of candidate incentive indicators in the e-commerce scenario is fully explored based on the expert knowledge of the e-commerce scenario in advance, to clarify an impact of different candidate incentive indicators on the target indicator. Then, the impact is expressed in an abstract manner, to construct the indicator causal graph of the target indicator in the e-commerce scenario.

The causal path between the target indicator and the target incentive indicator can be clarified through the indicator causal graph, so that the causal relationship between the e-commerce incentive task and the target to be incentivized can be clearly expressed, thereby helping to improve the selection accuracy.

Step S103: Predict an impact of the e-commerce incentive task on the target to be incentivized based on the causal relationship, to obtain a selection result of the e-commerce incentive task.

The causal relationship can clarify a relationship of interaction between the e-commerce incentive task and the target to be incentivized. Further, when an impact of the e-commerce incentive task on the target indicator is predicted, targeted analysis can be performed to reduce interference of another indicator on a prediction result, so that the obtained prediction result is more effective and more suitable for an actual situation in which the target indicator performs activities in the e-commerce scenario. Therefore, when the e-commerce incentive task is selected, the accuracy of the selection result can be improved.

In the method for e-commerce incentive task selection provided in this embodiment, the causal relationship between the e-commerce incentive task and the target to be incentivized is determined, so that the determined causal relationship can be more suitable for an operation state of the target to be incentivized in the e-commerce scenario. Further, when the effectiveness of the e-commerce incentive task is predicted based on the causal relationship, the obtained selection result of the e-commerce incentive task can be more accurate and effective.

FIG. 2 is a flowchart of a method for constructing an indicator causal graph according to an embodiment of the present disclosure. As shown in FIG. 2, the process includes the following steps.

Step S201: Determine a causal graph construction rule based on expert knowledge of an e-commerce scenario.

The expert knowledge may include industry insight, domain expertise, lessons learned, and the like. As such, the causal graph construction rule is determined based on the expert knowledge of the e-commerce scenario, thereby reducing errors and deviations. Therefore, the obtained causal graph construction rule is more reasonable and effective, so that a causal relationship between indicators is more suitable for a real causal relationship.

In some optional implementations, the above step S201 includes the following steps.

Step a1: Determine a global pointing rule between a plurality of candidate incentive indicators and a target indicator according to the expert knowledge of the e-commerce scenario.

The global pointing rule can be used to define and constrain the mutual influence and association between the target indicator and the plurality of candidate incentive indicators. For example, the global pointing rule can be used to specify how to set and adjust directions and priorities between different indicators. The global pointing rule may be a logical rule, a mathematical model, or a specified algorithm, which is not limited herein.

To make a relationship between indicators more accurate and reasonable, a relationship between the target indicator and each candidate incentive indicator is deeply explored according to the expert knowledge of the e-commerce scenario, and the relationship between the target indicator and respective candidate incentive indicators is weighted and optimized in combination with a plurality of business scenarios in the e-commerce scenario, so that pointing directions of the indicators are clarified, and the global pointing rule is obtained.

In some optional implementation scenarios, whether the e-commerce incentive task can effectively incentivize a target to be incentivized in the e-commerce scenario further depends on an entity corresponding to the target to be incentivized. The entity may be a consumer or a merchant. Therefore, to ensure rationality and integrity of the global pointing rule, an attribute indicator and a behavior indicator corresponding to the entity are obtained. As such, a relationship between the plurality of candidate incentive indicators, the attribute indicator of the entity, the behavior indicator of the entity, and the target indicator is explored in combination with the expert knowledge of the e-commerce scenario, and then a pointing relationship between the plurality of candidate incentive indicators, the attribute indicator of the entity, the behavior indicator of the entity, and the target indicator is clarified, thereby obtaining the global pointing rule. The attribute indicator of the entity may be understood as an indicator for measuring performance and an achievement of the entity in the e-commerce scenario. The behavior indicator of the entity may be understood as an indicator for measuring and evaluating a behavior of the entity in the e-commerce scenario. For example, if the entity is a merchant, the attribute indicator of the merchant includes but is not limited to any of the following indicators: an industry to which the merchant belongs, goods, and an organization to which the merchant belongs, and the like. The behavior indicator of the merchant includes but is not limited to any of the following indicators: an average daily live broadcast duration (live_hour_per_day), a live broadcast frequency (live_freq), a page view (PV), and a visit (VV), and the like. The target indicator includes but is not limited to any of the following indicators: a self-broadcast transaction amount (gmv_self_live) and a video transaction amount (gmv_self_video), and the like. The candidate incentive indicators may include but is not limited to: uploading a commodity video twice within a week, or completing a live broadcast task once a week, and the like.

In some other optional implementation scenarios, according to the expert knowledge of the e-commerce scenario, the pointing relationship between the plurality of candidate incentive indicators, the attribute indicator of the entity, the behavior indicator of the entity, and the target indicator may be determined as: the attribute indicator of the entity points to the candidate incentive indicator, the candidate incentive indicator points to the behavior indicator of the entity, and the behavior indicator of the entity points to the target indicator. Further, according to the pointing relationship, the global pointing rule shown in FIG. 3 can be obtained. In the figure, a symbol “x” on an arrow indicates that reverse pointing is not allowed.

Step a2: Determine a causal relationship between the plurality of candidate incentive indicators and the target indicator according to the global pointing rule to obtain the causal graph construction rule.

The global pointing rule can clarify an analysis direction of exploring a relationship of interaction between the target indicator and the plurality of candidate incentive indicators, thereby avoiding blind search and exploration. Furthermore, a causal relationship between the target indicator and the plurality of candidate incentive indicators can be quickly captured and determined to obtain the causal graph construction rule. As such, when an indicator causal graph is subsequently constructed, reliability and rationality of the indicator causal graph can be enhanced.

In an optional implementation scenario, a causal relationship between the target indicator and the plurality of candidate incentive indicators may be explored through a preset algorithm. For example, the preset algorithm may be a PC algorithm (PC algorithm, an algorithm for constructing a probability causal graph), a structural equation model (SEM, a statistical model), a Bayesian network, regression analysis, or the like, which is not limited herein.

In some other optional implementations, the above step S201 further includes the following steps.

Step a3: Identify whether there is a specified pointing rule in the e-commerce scenario.

The specified pointing rule is configured to specify a causal pointing relationship between different indicators. That is, the specified pointing rule is a pointing rule used to meet a personalized causal analysis requirement of a user. Different users have different causal analysis requirements when performing causal analysis. Therefore, to improve the effectiveness of constructing the indicator causal graph, whether there is the specified pointing rule in the e-commerce scenario is identified to determine whether a current user needs to specify a causal relationship between the plurality of indicators.

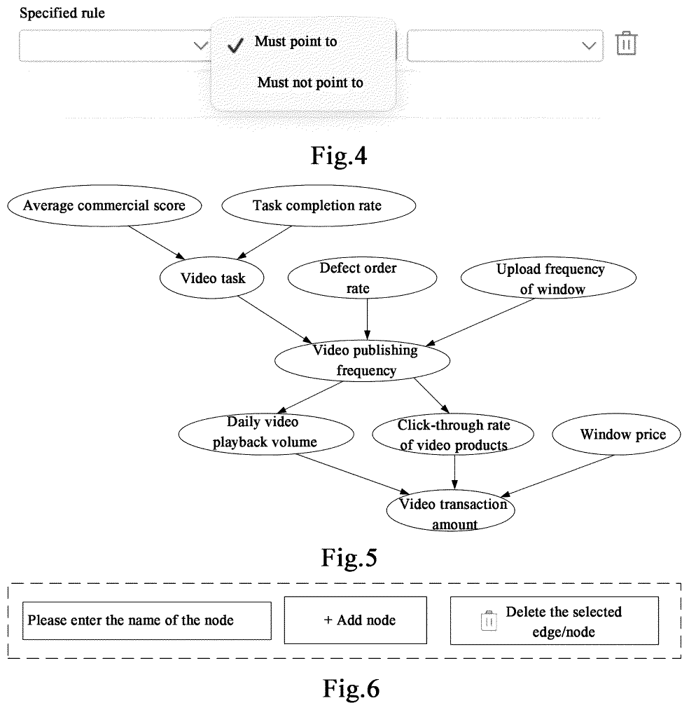

In an optional implementation scenario, if the user has a causal analysis requirement, the specified pointing rule may be set through an interactive operation with a rule adjustment control shown in FIG. 4.

Step a4: If there is the specified pointing rule, update the global pointing rule in terms of the specified pointing rule to obtain an updated global pointing rule.

Step S202: Arrange a causal relationship between the plurality of candidate incentive indicators and the target indicator in terms of the causal graph construction rule to obtain the indicator causal graph.

In terms of the causal graph construction rule, the relationship of interaction and the causal relationship flow direction between the indicators can be clarified, and then when the causal relationship between the target indicator and the plurality of candidate incentive indicators is arranged, it can be ensured that each indicator can be traced back to at least one candidate incentive indicator or the target indicator. As such, a causal path covering global indicators is formed, and the indicator causal graph that can clearly and reasonably represent a causal relationship between the indicators is obtained. In an optional implementation scenario, the obtained indicator causal graph may be shown in FIG. 5.

In some optional implementations, the above step S202 includes the following steps.

Step b1: Arrange a causal relationship between the plurality of candidate incentive indicators and the target indicator in terms of the causal graph construction rule to obtain an initial indicator causal graph.

Step b2: Adjust the initial indicator causal graph in response to a received modification instruction to obtain the indicator causal graph.

Specifically, the causal relationship between the target indicator and the plurality of candidate incentive indicators is arranged in terms of the causal graph construction rule to obtain the initial indicator causal graph.

When the modification instruction is received, it indicates that a relevant person believes that the currently obtained initial indicator causal graph cannot meet his own causal analysis requirement. Therefore, the initial indicator causal graph is adjusted in response to the modification instruction until the indicator causal graph that can meet the causal analysis requirement is obtained. The modification instruction includes but is not limited to at least one of the following adjustments to the initial indicator causal graph: deleting a node in the initial indicator causal graph, adding a node to the initial indicator causal graph, deleting an edge in the initial indicator causal graph, and adding an edge to the initial indicator causal graph. Different nodes represent different indicators, and an edge between two nodes represents a causal relationship between indicators corresponding to the two nodes. The modification content in the modification instruction may be determined based on content supplemented with expert knowledge.

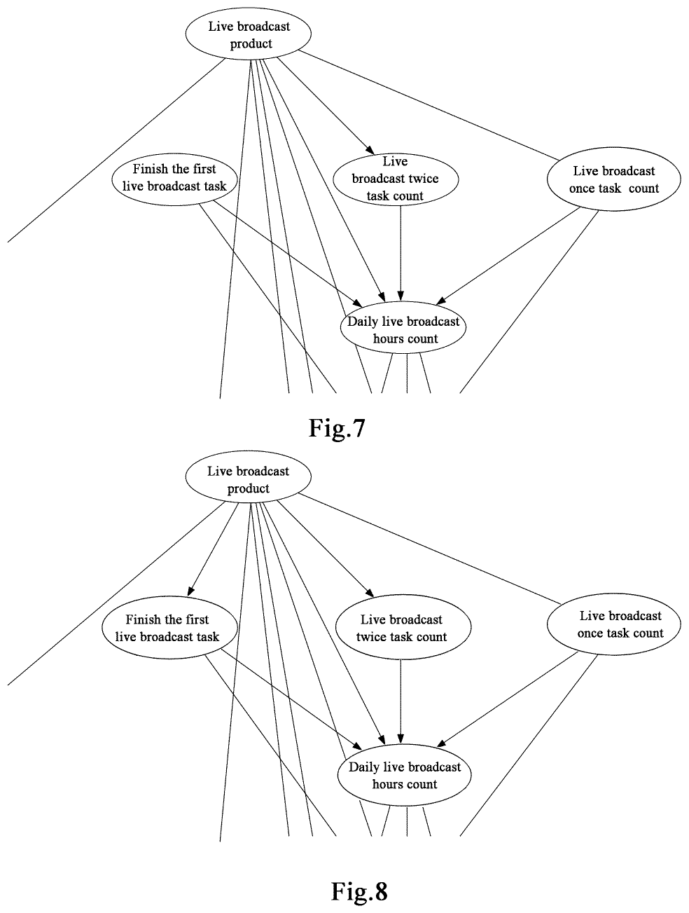

In some optional implementations, as shown in FIG. 6, a node or an edge that needs to be adjusted may be determined through an arrangement adjustment control. If a node in the initial indicator causal graph needs to be deleted, the node that needs to be deleted is entered in the arrangement adjustment control, and then the node is deleted from the initial indicator causal graph. If an edge needs to be added, two nodes of the edge that needs to be added are entered in the arrangement adjustment control, to clarify an addition position of the edge, so that the initial indicator causal graph is specifically adjusted. For example, as shown in FIG. 7, nodes of the edge that need to be added are a live broadcast product (live_product) and a completed first live broadcast task (finish_first_live_task), and the two nodes are entered in the arrangement adjustment control shown in FIG. 6, to obtain the indicator causal graph shown in FIG. 8. FIG. 7 and FIG. 8 are both example partial schematic diagrams.

In an optional implementation scenario, the arrangement adjustment control further includes a reset control. When a relevant person gives up a current adjustment to the initial indicator causal graph, the initial indicator causal graph can be restored based on the interactive operation with the reset control, so that the adjustment manner of the initial indicator causal graph is more flexible.

In an example, if the user does not issue the modification instruction, the initial indicator causal graph is used as the indicator causal graph that is finally required.

When constructing the indicator causal graph provided in this embodiment, the indicator causal graph is constructed based on the expert knowledge of the e-commerce scenario, so that a possible misleading or incorrect causal relationship can be effectively identified and excluded. This helps to enhance the accuracy and reliability of the indicator causal graph, so that the obtained indicator causal graph can effectively express a causal relationship between the target indicator and the candidate incentive indicators in the e-commerce scenario, thereby improving the effectiveness of the selection result.

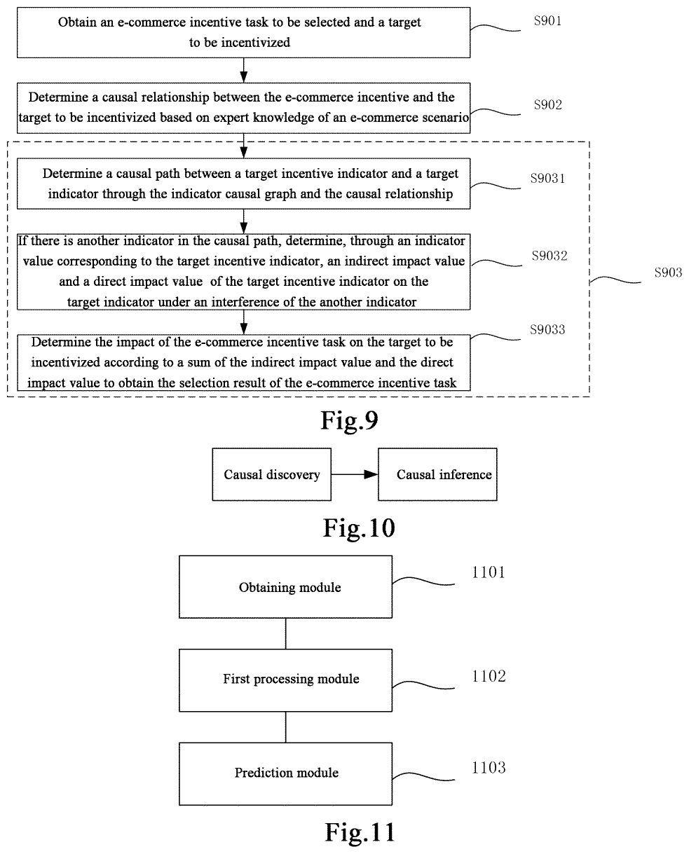

A method for e-commerce incentive task selection is provided in this embodiment, which may be applied to the above computer device, such as a computer, a mobile phone, a tablet computer, and the like. FIG. 9 is a flowchart of a method for e-commerce incentive task selection according to an embodiment of the present disclosure. As shown in FIG. 9, the process includes the following steps.

Step S901: Obtain an e-commerce incentive task to be selected and a target to be incentivized. Please refer to step S101 of the embodiment shown in FIG. 1 for details, which will not be described repeatedly here.

Step S902: Determine a causal relationship between the e-commerce incentive task and the target to be incentivized based on expert knowledge of an e-commerce scenario. Please refer to step S102 of the embodiment shown in FIG. 1 for details, which will not be described repeatedly here.

Step S903: Predict an impact of the e-commerce incentive task on the target to be incentivized based on the causal relationship to obtain a selection result of the e-commerce incentive task.

Specifically, the above step S903 includes the following steps.

Step S9031: Determine a causal path between a target incentive indicator and a target indicator through the indicator causal graph and the causal relationship.

The indicator causal graph can clearly and explicitly represent a causal relationship between the indicators. Therefore, to determine the impact of the target incentive indicator on the target indicator, the causal path between the target incentive indicator and the target indicator is determined from the indicator causal graph, so that a prediction result obtained later when the impact of the e-commerce incentive task on the target to be incentivized is predicted can be more reasonable and more helpful for targeted selection.

Step S9032: If there is another indicator in the causal path, determine, through an indicator value corresponding to the target incentive indicator, an indirect impact value and a direct impact value of the target incentive indicator on the target indicator under an interference of the other indicator.

If there is another indicator in the causal path, it indicates that the target incentive indicator does not directly impact the target indicator. Therefore, to determine whether an impact of the target incentive indicator on the target indicator is a positive correlation impact, an indirect impact value and a direct impact value of the target incentive indicator on the target indicator under an interference of the other indicator are determined based on a change of the indicator value corresponding to the target incentive indicator. Then, an indirect impact degree of the target incentive indicator on the target indicator is measured according to the obtained indirect impact value; and a direct impact degree of the target incentive indicator on the target indicator is measured according to the obtained direct impact value.

In some optional implementations, the other indicator comprises a plurality of mediation indicators and a confounding indicator, and the above step S9032 includes the following steps.

Step c1: Determine an indicator change amount of the target incentive indicator according to an initial indicator value of the target incentive indicator before adjustment and a final indicator value of the target incentive indicator after adjustment.

Step c2: Determine the direct impact value of the target incentive indicator on the target indicator through the indicator change amount based on a first regression processing result of performing regression processing on mediation variables corresponding to the plurality of mediation indicators and a confounding variable corresponding to the confounding indicator.

Step c3: Determine the indirect impact value of the target incentive indicator on the target indicator through the initial indicator value based on a second regression processing result of performing regression processing on the mediation variables corresponding to the plurality of mediation indicators and the confounding variable corresponding to the confounding indicator.

To understand the impact of the target incentive indicator on the target indicator more comprehensively, a role of the other indicator in the causal path is analyzed based on an arrangement position of the other indicator in the causal path, and then the mediation indicator and the confounding indicator in the causal path are identified. The mediation indicator refers to an indicator that plays a role of transmission, transformation, or adjustment in the causal path, and transmits the impact of the target incentive indicator to the target indicator. The confounding indicator refers to an indicator that interferes with the mediation indicator in transmitting the impact of the target incentive indicator to the target indicator in the causal path.

The plurality of mediation indicators and the confounding indicator in the causal path may be identified in a manner of backdoor control. Principles related to backdoor control are as follows: An interference path (a path in an indicator causal graph in which an unobserved indicator is connected to the causal path) is blocked by identifying and selecting an appropriate control variable in the indicator causal graph, so that the causal path between the target incentive indicator and the target indicator is used as a unique information source.

A mediation indicator M needs to meet the following conditions:
(1) There is no descendant node of the target incentive indicator X in the mediation indicator M; and
(2) The mediation indicator M blocks all paths from the target incentive indicator X to the target indicator Y.

When there are a large number of mediation indicators, the confounding indicator needs to meet the following conditions: T_{t,m}∥T|C, Y_{t,m}∥M|C{T, C}, Mₜ∥T|C and Y_{t,m}∥M_{t*}|C, where T represents the target incentive indicator, t represents a current indicator value of the target incentive indicator, m represents a current mediation indicator, C represents the confounding indicator, M represents the mediation indicator, and Y represents the target indicator. The confounding indicator is selected in this manner, so that when an indirect impact and a direct impact of the target incentive indicator on the target indicator are determined, confounding variables between the target incentive indicator and the mediation indicator, between the mediation indicator and the target indicator, and between the target incentive indicator and the target indicator can be controlled, thereby effectively improving the accuracy of the prediction result.

When the mediation indicator and the confounding indicator are determined, regression processing is performed on mediation variables corresponding to the plurality of mediation indicators and confounding variables corresponding to the confounding indicator by using a preset first regression function, to obtain the first regression processing result.

To avoid endogeneity and control each confounding variable in the confounding indicator, an expression of the preset first regression function is as follows:

$$E [ {M}^{i} \vert t , C ] = {β}_{0}^{i} + {β}_{1}^{i} t + {β}_{2}^{i} C ; i = 1 , … , K ,$$

where K represents a total quantity of the mediation indicators, t represents a final indicator value of the target incentive indicator, C represents the confounding variable, M represents the mediation variable, β₀ⁱ represents an unbiased estimation coefficient when both t and C are 0, β₁ⁱ represents a coefficient of unbiased estimation of t, and β₂ⁱ represents a coefficient of unbiased estimation of C,
and where β₁ⁱ is the first regression processing result that is finally required.

The direct impact value NIE of the impact of the target incentive indicator on the target indicator is determined through the indicator change amount by using the following formula while ignoring an impact of the other indicator:

$$NIE = E [ {Y}_{t , {M}_{t}} - {Y}_{t , {M}_{t *}} \vert C ] = {\sum }_{k = 1}^{K} {β}_{1}^{i} \cdot {θ}_{2}^{k} ( t - t \text{*)} ;$$

where t represents the final indicator value of the target incentive indicator, t* represents the initial indicator value of the target incentive indicator, and θ₂^{k} represents a coefficient of estimation of the current mediation variable.

Regression processing is performed on the mediation variables corresponding to the plurality of mediation indicators and the confounding variable corresponding to the confounding indicator by using a preset second regression function as follows, to obtain a second regression processing result:

$$E [ Y \vert t , m , C ] = {θ}_{0} + {θ}_{1} t + {θ}_{2}^{1} m + {θ}_{2}^{2} {m}^{2} + … + {θ}_{2}^{K} {m}^{K} + {\dot{θ}}_{4} C ;$$

where θ₀ represents an estimation coefficient when both t and Care 0, θ₁ represents a coefficient of estimation of t, and θ₂^{k} represents a coefficient of estimation of the current mediation variable.

The indirect impact value NDE of the impact of the target incentive indicator on the target indicator under an interference of the other indicator is determined through the initial indicator value by using the following formula:

$$N D E = E [ {Y}_{t , {M}_{t *}} - {Y}_{t * , {M}_{t *}} \vert C ] = {θ}_{1} ( t - t * ) .$$

That is, the direct impact value NIE can explain that the target incentive indicator impacts the target indicator by affecting the mediation indicator; and the indirect impact value NDE can explain that the target incentive indicator directly impacts the target indicator when an impact of the target incentive indicator on the mediation indicator is ignored.

Step S9033: Determine the impact of the e-commerce incentive task on the target to be incentivized according to a sum of the indirect impact value and the direct impact value to obtain the selection result of the e-commerce incentive task.

The sum of the indirect impact value and the direct impact value can clarify an average impact value of the target incentive indicator on the target indicator during a process in which the target incentive indicator is adjusted from the initial indicator value to the final indicator value, so that the impact of the e-commerce incentive task on the target to be incentivized can be concretely expressed, thereby simplifying the selection difficulty, and helping to improve the efficiency of selecting the e-commerce incentive task, thereby facilitating quick determination of the selection result.

In some optional implementations, if the sum of the indirect impact value and the direct impact value is greater than a preset threshold, it indicates that the e-commerce incentive task can effectively incentivize the target to be incentivized. Therefore, it is determined that the impact of the e-commerce incentive task on the target to be incentivized is a positive correlation impact, and the e-commerce incentive task is retained.

In some other optional implementations, if the sum of the indirect impact value and the direct impact value is less than or equal to the preset threshold, it indicates that the e-commerce incentive task cannot effectively incentivize the target to be incentivized. Therefore, the e-commerce incentive task is not retained.

In some further optional implementations, to improve the utilization rate of the e-commerce incentive task, the e-commerce incentive task that is not retained is specifically adjusted based on the obtained indirect impact value and direct impact value, until the finally determined sum of the indirect impact value and the direct impact value is greater than the preset threshold.

In the method for e-commerce incentive task selection provided in this embodiment, an impact of the e-commerce incentive task on the target to be incentivized can be deeply explored based on an indirect impact and a direct impact of the causal relationship by the mediation indicator, so that the obtained selection result is more scientific and more reasonable.

As one or more specific application implementations of the embodiments of the present disclosure, as shown in FIG. 10, to determine an impact of an e-commerce incentive task on a target to be incentivized in an e-commerce scenario, targeted prediction may be performed through two steps: causal discovery and causal inference.

The purpose of the causal discovery step is to determine a causal relationship between the e-commerce incentive task and the target to be incentivized. Specifically, if there is currently an indicator causal graph in the e-commerce scenario, the causal relationship between the e-commerce incentive task and the target to be incentivized is determined through the indicator causal graph.

If there is no indicator causal graph in the e-commerce scenario currently, an indicator system is pre-constructed by combining a plurality of candidate incentive indicators, the target indicator, attribute indicators of a plurality of entities, and corresponding behavior indicators. A causal relationship between the indicators in the indicator system is specially sorted out based on the expert knowledge of the e-commerce scenario, to obtain an initial indicator causal graph. The initial indicator causal graph is adjusted based on the supplementary content of the expert knowledge, and the adjusted initial indicator causal graph is used as the indicator causal graph that is finally used to analyze a causal relationship between the target incentive indicator and the target indicator. Then, the causal relationship between the e-commerce incentive task and the target to be incentivized is determined through the indicator causal graph.

The purpose of the causal inference step is to predict an impact of the e-commerce incentive task on the target to be incentivized. Specifically, a causal path between the target incentive indicator and the target indicator is determined through the indicator causal graph and the causal relationship. If there is another indicator in the causal path, a mediation indicator and a confounding indicator in the causal path are identified based on an arrangement position of the other indicator in the causal path. An indirect impact value and a direct impact value of a mediation indicator on the causal relationship under influence of the confounding indicator are determined by adjusting an indicator value corresponding to the target incentive indicator. The impact of the e-commerce incentive task on the target to be incentivized is determined according to a sum of the indirect impact value and the direct impact value, to obtain the selection result of the e-commerce incentive task, so that the obtained selection result of the e-commerce incentive task is more accurate and effective.

An e-commerce incentive task selection apparatus is further provided in this embodiment. The apparatus is configured to implement the above embodiments and preferred implementations, which have been described will not be described repeatedly here. As used below, the term “module” may be a combination of software and/or hardware that implements a predetermined function. Although the apparatus described in the following embodiments is preferably implemented by software, an implementation of hardware or a combination of software and hardware is also possible and contemplated.

An e-commerce incentive task selection apparatus is provided in this embodiment. As shown in FIG. 11, the apparatus includes:
an obtaining module 1101, configured to obtain an e-commerce incentive task to be selected and a target to be incentivized;
a first processing module 1102, configured to determine a causal relationship between the e-commerce incentive task and the target to be incentivized based on expert knowledge of an e-commerce scenario, wherein the causal relationship is obtained through a pre-constructed indicator causal graph, the indicator causal graph is configured to represent a causal relationship between a plurality of candidate incentive indicators and a target indicator corresponding to the target to be incentivized in the e-commerce scenario, and the plurality of candidate incentive indicators comprise a target incentive indicator corresponding to the e-commerce incentive task; and
a prediction module 1103, configured to predict an impact of the e-commerce incentive task on the target to be incentivized based on the causal relationship to obtain a selection result of the e-commerce incentive task.

In some optional implementations, the indicator causal graph construction apparatus includes:
a second processing module, configured to determine a causal graph construction rule based on expert knowledge of an e-commerce scenario; and
a construction module, configured to arrange a causal relationship between the plurality of candidate incentive indicators and the target indicator in terms of the causal graph construction rule to obtain the indicator causal graph.

In some optional implementations, the second processing module includes:
a first execution unit, configured to determine a global pointing rule between a plurality of candidate incentive indicators and a target indicator according to the expert knowledge of the e-commerce scenario; and
a second execution unit, configured to determine a causal relationship between the plurality of candidate incentive indicators and the target indicator according to the global pointing rule to obtain the causal graph construction rule.

In some optional implementations, the second processing module further includes:
a first identification unit, configured to identify whether there is a specified pointing rule in the e-commerce scenario, where the specified pointing rule is configured to specify a causal pointing relationship between different indicators; and
an update unit, configured to update the global pointing rule in terms of the specified pointing rule if there is the specified pointing rule to obtain an updated global pointing rule.

In some optional implementations, the construction module includes:
a third execution unit, configured to arrange a causal relationship between the plurality of candidate incentive indicators and the target indicator in terms of the causal graph construction rule to obtain an initial indicator causal graph; and
an adjustment unit, configured to adjust the initial indicator causal graph in response to a received modification instruction to obtain the indicator causal graph.

In some optional implementations, the prediction module 1103 includes:
a fourth execution unit, configured to determine a causal path between a target incentive indicator and a target indicator through the indicator causal graph and the causal relationship;
a second identification unit, configured to determine, through an indicator value corresponding to the target incentive indicator, an indirect impact value and a direct impact value of the target incentive indicator on the target indicator under an interference of another indicator if there is the other indicator in the causal path; and
a fifth execution unit, configured to determine the impact of the e-commerce incentive task on the target to be incentivized according to a sum of the indirect impact value and the direct impact value to obtain the selection result of the e-commerce incentive task.

In some optional implementations, the other indicator comprises a plurality of mediation indicators and a confounding indicator, and the fifth execution unit includes:
a first determination unit, configured to determine an indicator change amount of the target incentive indicator according to an initial indicator value of the target incentive indicator before adjustment and a final indicator value of the target incentive indicator after adjustment;
a second determination unit, configured to determine the direct impact value of the target incentive indicator on the target indicator through the indicator change amount based on a first regression processing result of performing regression processing on mediation variables corresponding to the plurality of mediation indicators and a confounding variable corresponding to the confounding indicator; and
a third determination unit, configured to determine the indirect impact value of the target incentive indicator on the target indicator through the initial indicator value based on a second regression processing result of performing regression processing on the mediation variables corresponding to the plurality of mediation indicators and the confounding variable corresponding to the confounding indicator.

In some optional implementations, the sixth execution unit includes:
a fourth determination unit, configured to determine that the impact of the e-commerce incentive task on the target to be incentivized is a positive correlation impact, and retain the e-commerce incentive task if the sum of the indirect impact value and the direct impact value is greater than a preset threshold.

Further function descriptions of the above modules and units are the same as those of the corresponding embodiments. Details will not be described repeatedly here.

The e-commerce incentive task selection apparatus in this embodiment is presented in the form of a functional unit. The unit herein refers to an ASIC (Application Specific Integrated Circuit) circuit, a processor that executes one or more software or firmware programs and a memory, and/or another device that can provide the above functions.

An embodiment of the present disclosure further provides an electronic device, comprising the e-commerce incentive task selection apparatus shown in FIG. 11.

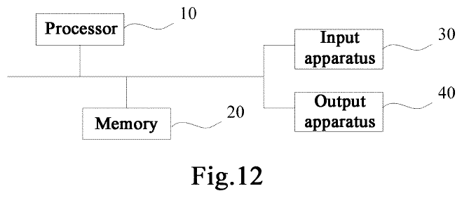

Referring to FIG. 12, FIG. 12 is a schematic diagram of a structure of an electronic device according to an optional embodiment of the present disclosure. As shown in FIG. 12, the electronic device includes one or more processors 10, a memory 20, and an interface for connecting various components, including a high-speed interface and a low-speed interface. The various components communicate with each other through different buses, and may be mounted on a common mainboard or otherwise mounted as required. The processor may process instructions executed in the electronic device, including instructions stored in the memory or on the memory and used to display graphical information of a GUI on an external input/output apparatus (such as a display apparatus coupled to the interface). In some optional implementations, if necessary, a plurality of processors and/or a plurality of buses may be used together with a plurality of memories and the plurality of memories. Similarly, a plurality of electronic devices may be connected, and each device provides some necessary operations (for example, as a server array, a group of blade servers, or a multi-processor system). FIG. 12 shows an example in which there is one processor 10.

The processor 10 may be a central processing unit, a network processor or a combination thereof. The processor 10 may further include a hardware chip. The above hardware chip may be an ASIC, a programmable logic device, or a combination thereof. The above programmable logic device may be a complex programmable logic device, a field programmable gate array, a general-purpose array logic, or any combination thereof.

The memory 20 stores instructions executable by at least one processor 10, so that the at least one processor 10 executes a method shown in the above embodiment.

The memory 20 may include a program storage area and a data storage area. The program storage area may store an operating system and an application program required for at least one function. The data storage area may store data created according to the use of the electronic device, and the like. In addition, the memory 20 may include a high-speed random access memory, and may further include a non-volatile memory, for example, at least one magnetic disk storage device, a flash memory device, or another non-volatile solid-state storage device. In some optional implementations, the memory 20 optionally includes a memory remotely arranged relative to the processor 10, and the remote memory may be connected to the electronic device through a network. Examples of the above network include, but are not limited to, the Internet, an intranet, a local area network, a mobile communication network, and a combination thereof.

The memory 20 may include a volatile memory, for example, a random access memory. The memory may also include a non-volatile memory, for example, a flash memory, a hard disk, or a solid-state hard disk. The memory 20 may further include a combination of the foregoing types of memories.

The electronic device further includes an input apparatus 30 and an output apparatus 40. The processor 10, the memory 20, the input apparatus 30, and the output apparatus 40 may be connected through a bus or in another manner. FIG. 12 shows an example in which they are connected through a bus.

An embodiment of the present disclosure further provides a computer-readable storage medium. The method according to the embodiment of the present disclosure may be implemented in hardware or firmware, or may be implemented as computer code that can be recorded in a storage medium, or may be implemented as original computer code stored in a remote storage medium or a non-transitory machine-readable storage medium through network download and stored in a local storage medium, so that the method described herein may be stored in such software processing on a storage medium using a general-purpose computer, a special-purpose processor, or programmable or special-purpose hardware. The storage medium may be a magnetic disk, an optical disc, a read-only memory (ROM), a random access memory (RAM), a flash memory, a hard disk, or a solid-state hard disk. Further, the storage medium may further include a combination of the foregoing types of memories. It may be understood that a computer, a processor, a microprocessor controller, or programmable hardware includes a storage component that may store or receive software or computer code, and when the software or computer code is accessed and executed by the computer, the processor, or the hardware, the method shown in the above embodiment is implemented.

It may be understood that before a technical solution disclosed in each embodiment of the present disclosure is used, a user shall be informed of a type, a use scope, a use scenario, and the like of personal information involved in the present disclosure in an appropriate manner and the user's authorization shall be obtained in accordance with relevant laws and regulations.

For example, when a user's active request is received, prompt information is sent to the user to explicitly prompt the user that the operation requested by the user will need to acquire and use the user's personal information. Therefore, the user may independently choose whether to provide the personal information to software or hardware such as an electronic device, an application, a server, or a storage medium that performs an operation of the technical solution of the present disclosure according to the prompt information.

As an optional but non-limiting implementation manner, for example, a manner of sending prompt information to a user in response to receiving the user's active request may be a pop-up window manner, and the prompt information may be presented in text in the pop-up window. In addition, a selection control for allowing the user to select “agree” or “disagree” to provide the personal information to the electronic device may also be carried in the pop-up window.

It may be understood that the above notification and user authorization obtaining process is merely illustrative, and does not limit the implementation manner of the present disclosure. Other manners that comply with relevant laws and regulations may also be applied to the implementation manner of the present disclosure.

Although the embodiments of the present disclosure are described with reference to the accompanying drawings, those skilled in the art may make various modifications and variations without departing from the spirit and scope of the present disclosure, and such modifications and variations all fall within the scope defined by the appended claims.

I/We claim:

1. A method for e-commerce incentive task selection comprising:
obtaining an e-commerce incentive task to be selected and a target to be incentivized;
determining a causal relationship between the e-commerce incentive task and the target to be incentivized based on expert knowledge of an e-commerce scenario, wherein the causal relationship is obtained through a pre-constructed indicator causal graph, the indicator causal graph is configured to represent a causal relationship between a plurality of candidate incentive indicators and a target indicator corresponding to the target to be incentivized in the e-commerce scenario, and the plurality of candidate incentive indicators comprise a target incentive indicator corresponding to the e-commerce incentive task; and
predicting an impact of the e-commerce incentive task on the target to be incentivized based on the causal relationship to obtain a selection result of the e-commerce incentive task.

2. The method of claim 1, wherein the indicator causal graph is constructed by:
determining a causal graph construction rule based on the expert knowledge of the e-commerce scenario; and
arranging a causal relationship between the plurality of candidate incentive indicators and the target indicator in terms of the causal graph construction rule to obtain the indicator causal graph.

3. The method of claim 2, wherein determining the causal graph construction rule based on the expert knowledge of the e-commerce scenario comprises:
determining a global pointing rule between the plurality of candidate incentive indicators and the target indicator according to the expert knowledge of the e-commerce scenario; and
determining the causal relationship between the plurality of candidate incentive indicators and the target indicator according to the global pointing rule to obtain the causal graph construction rule.

4. The method of claim 3, wherein determining the causal graph construction rule based on the expert knowledge of the e-commerce scenario further comprises:
identifying whether there is a specified pointing rule in the e-commerce scenario, wherein the specified pointing rule is configured to specify a causal pointing relationship between different indicators; and
in accordance with a determination that there is the specified pointing rule, updating the global pointing rule in terms of the specified pointing rule to obtain an updated global pointing rule.

5. The method of claim 2, wherein arranging the causal relationship between the plurality of candidate incentive indicators and the target indicator in terms of the causal graph construction rule to obtain the indicator causal graph comprises:
arranging the causal relationship between the plurality of candidate incentive indicators and the target indicator in terms of the causal graph construction rule to obtain an initial indicator causal graph; and
in response to a received modification instruction, adjusting the initial indicator causal graph to obtain the indicator causal graph.

6. The method of claim 1, wherein predicting the impact of the e-commerce incentive task on the target to be incentivized based on the causal relationship to obtain the selection result of the e-commerce incentive task comprises:
determining a causal path between the target incentive indicator and the target indicator through the indicator causal graph and the causal relationship;
in accordance with a determination that there is another indicator in the causal path, determining, through an indicator value corresponding to the target incentive indicator, an indirect impact value and a direct impact value of the target incentive indicator on the target indicator under an interference of the other indicator; and
determining the impact of the e-commerce incentive task on the target to be incentivized according to a sum of the indirect impact value and the direct impact value to obtain the selection result of the e-commerce incentive task.

7. The method of claim 6, wherein the other indicator comprises a plurality of mediation indicators and a confounding indicator, and wherein determining, through the indicator value corresponding to the target incentive indicator, the indirect impact value and the direct impact value of the target incentive indicator on the target indicator under the interference of the other indicator comprises:
determining an indicator change amount of the target incentive indicator according to an initial indicator value of the target incentive indicator before adjustment and a final indicator value of the target incentive indicator after adjustment;
determining the direct impact value of the target incentive indicator on the target indicator through the indicator change amount based on a first regression processing result of performing regression processing on mediation variables corresponding to the plurality of mediation indicators and a confounding variable corresponding to the confounding indicator; and
determining the indirect impact value of the target incentive indicator on the target indicator through the initial indicator value based on a second regression processing result of performing regression processing on the mediation variables corresponding to the plurality of mediation indicators and the confounding variable corresponding to the confounding indicator.

8. The method of claim 6, wherein determining the impact of the e-commerce incentive task on the target to be incentivized according to the sum of the indirect impact value and the direct impact value to obtain the selection result of the e-commerce incentive task comprises:
in accordance with a determination that the sum of the indirect impact value and the direct impact value is greater than a preset threshold, determining that the impact of the e-commerce incentive task on the target to be incentivized is a positive correlation impact, and retaining the e-commerce incentive task.

9. An electronic device, comprising:
a memory and a processor, wherein the memory and the processor are in communication connection with each other, a computer instruction is stored on the memory, and the processor executes the computer instruction to:
obtain an e-commerce incentive task to be selected and a target to be incentivized;
determine a causal relationship between the e-commerce incentive task and the target to be incentivized based on expert knowledge of an e-commerce scenario, wherein the causal relationship is obtained through a pre-constructed indicator causal graph, the indicator causal graph is configured to represent a causal relationship between a plurality of candidate incentive indicators and a target indicator corresponding to the target to be incentivized in the e-commerce scenario, and the plurality of candidate incentive indicators comprise a target incentive indicator corresponding to the e-commerce incentive task; and
predict an impact of the e-commerce incentive task on the target to be incentivized based on the causal relationship to obtain a selection result of the e-commerce incentive task.

10. The electronic device of claim 9, wherein the indicator causal graph is constructed by:
determining a causal graph construction rule based on the expert knowledge of the e-commerce scenario; and
arranging a causal relationship between the plurality of candidate incentive indicators and the target indicator in terms of the causal graph construction rule to obtain the indicator causal graph.

11. The electronic device of claim 10, wherein determining the causal graph construction rule based on the expert knowledge of the e-commerce scenario comprises:
determining a global pointing rule between the plurality of candidate incentive indicators and the target indicator according to the expert knowledge of the e-commerce scenario; and
determining the causal relationship between the plurality of candidate incentive indicators and the target indicator according to the global pointing rule to obtain the causal graph construction rule.

12. The electronic device of claim 11, wherein determining the causal graph construction rule based on the expert knowledge of the e-commerce scenario further comprises:
identifying whether there is a specified pointing rule in the e-commerce scenario, wherein the specified pointing rule is configured to specify a causal pointing relationship between different indicators; and
in accordance with a determination that there is the specified pointing rule, updating the global pointing rule in terms of the specified pointing rule to obtain an updated global pointing rule.

13. The electronic device of claim 10, wherein arranging the causal relationship between the plurality of candidate incentive indicators and the target indicator in terms of the causal graph construction rule to obtain the indicator causal graph comprises:
arranging the causal relationship between the plurality of candidate incentive indicators and the target indicator in terms of the causal graph construction rule to obtain an initial indicator causal graph; and
in response to a received modification instruction, adjusting the initial indicator causal graph to obtain the indicator causal graph.

14. The electronic device of claim 9, wherein predicting the impact of the e-commerce incentive task on the target to be incentivized based on the causal relationship to obtain the selection result of the e-commerce incentive task comprises:
determining a causal path between the target incentive indicator and the target indicator through the indicator causal graph and the causal relationship;
in accordance with a determination that there is another indicator in the causal path, determining, through an indicator value corresponding to the target incentive indicator, an indirect impact value and a direct impact value of the target incentive indicator on the target indicator under an interference of the other indicator; and
determining the impact of the e-commerce incentive task on the target to be incentivized according to a sum of the indirect impact value and the direct impact value to obtain the selection result of the e-commerce incentive task.

15. The electronic device of claim 14, wherein the other indicator comprises a plurality of mediation indicators and a confounding indicator, and wherein determining, through the indicator value corresponding to the target incentive indicator, the indirect impact value and the direct impact value of the target incentive indicator on the target indicator under the interference of the other indicator comprises:
determining an indicator change amount of the target incentive indicator according to an initial indicator value of the target incentive indicator before adjustment and a final indicator value of the target incentive indicator after adjustment;
determining the direct impact value of the target incentive indicator on the target indicator through the indicator change amount based on a first regression processing result of performing regression processing on mediation variables corresponding to the plurality of mediation indicators and a confounding variable corresponding to the confounding indicator; and
determining the indirect impact value of the target incentive indicator on the target indicator through the initial indicator value based on a second regression processing result of performing regression processing on the mediation variables corresponding to the plurality of mediation indicators and the confounding variable corresponding to the confounding indicator.

16. The electronic device of claim 14, wherein determining the impact of the e-commerce incentive task on the target to be incentivized according to the sum of the indirect impact value and the direct impact value to obtain the selection result of the e-commerce incentive task comprises:
in accordance with a determination that the sum of the indirect impact value and the direct impact value is greater than a preset threshold, determining that the impact of the e-commerce incentive task on the target to be incentivized is a positive correlation impact, and retaining the e-commerce incentive task.

17. A non-transitory computer-readable storage medium, having a computer instruction stored thereon, and the computer instruction is configured to enable a computer to:
obtain an e-commerce incentive task to be selected and a target to be incentivized;
determine a causal relationship between the e-commerce incentive task and the target to be incentivized based on expert knowledge of an e-commerce scenario, wherein the causal relationship is obtained through a pre-constructed indicator causal graph, the indicator causal graph is configured to represent a causal relationship between a plurality of candidate incentive indicators and a target indicator corresponding to the target to be incentivized in the e-commerce scenario, and the plurality of candidate incentive indicators comprise a target incentive indicator corresponding to the e-commerce incentive task; and
predict an impact of the e-commerce incentive task on the target to be incentivized based on the causal relationship to obtain a selection result of the e-commerce incentive task.

18. The non-transitory computer-readable storage medium of claim 17, wherein the construction of the indicator causal graph comprises:
determining a causal graph construction rule based on the expert knowledge of the e-commerce scenario; and
arranging a causal relationship between the plurality of candidate incentive indicators and the target indicator in terms of the causal graph construction rule to obtain the indicator causal graph.

19. The non-transitory computer-readable storage medium of claim 18, wherein determining the causal graph construction rule based on the expert knowledge of the e-commerce scenario comprises:
determining a global pointing rule between the plurality of candidate incentive indicators and the target indicator according to the expert knowledge of the e-commerce scenario; and
determining the causal relationship between the plurality of candidate incentive indicators and the target indicator according to the global pointing rule to obtain the causal graph construction rule.

20. The non-transitory computer-readable storage medium of claim 19, wherein determining the causal graph construction rule based on the expert knowledge of the e-commerce scenario further comprises:
identifying whether there is a specified pointing rule in the e-commerce scenario, wherein the specified pointing rule is configured to specify a causal pointing relationship between different indicators; and
if there is the specified pointing rule, updating the global pointing rule in terms of the specified pointing rule to obtain an updated global pointing rule.
